(19) United States
(12) Patent Application Publication
(10) Pub. No.: US 2026/0175696 A1
(43) Pub. Date: Jun. 25, 2026

(54) ASSURED CONTROL FOR ROBOTIC VEHICLES

(71) Applicant: Textron Systems Corporation, Hunt Valley, MD (US)

(72) Inventors: Aaron Russell Grieb, Spring Grove, PA (US); Matthew Thomas Standiford, Towson, MD (US); Christopher Otis Bowen, Parkton, MD (US); Bradley S. Galloway, Seven Valleys, PA (US)

(21) Appl. No.: 19/426,799

(22) Filed: Dec. 19, 2025

Related U.S. Application Data
(60) Provisional application No. 63/737,989, filed on Dec. 23, 2024.

(51) Int. Cl. B60L 3/04; B60L 15/20; G05D 1/225

(52) U.S. Cl. CPC B60L 3/04; B60L 15/20; G05D 1/225

(57) ABSTRACT

Techniques are directed to operating a remotely controlled vehicle. Such techniques involve receiving a set of vehicle controller signals from a vehicle controller which is external to the remotely controlled vehicle, the set of vehicle controller signals identifying a set of expected vehicle conditions. Such techniques further involve receiving a set of vehicle sensor signals from a set of sensors of the remotely controlled vehicle, the set of vehicle sensor signals identifying a set of actual vehicle conditions. Such techniques further involve, based on the set of vehicle controller signals and the set of vehicle sensor signals, performing a safety evaluation operation which outputs a safety evaluation signal indicating whether the set of actual vehicle conditions aligns with the set of expected vehicle conditions.

### CROSS REFERENCE TO RELATED APPLICATIONS

This application is a regular utility application based on earlier-filed U.S. Application No. 63/737,989 filed on December 23, 2024, entitled "Assured Control for Robotic Vehicles", the contents and teachings of which are hereby incorporated by reference in their entirety.

### BACKGROUND

A robotic vehicle does not require a human operator to be onboard. Rather, the human operator may control the robotic vehicle from another location (e.g., from within a different vehicle which is escorted by the robotic vehicle, from a base station miles away, etc.).

### BRIEF DESCRIPTION OF THE DRAWINGS

The foregoing and other objects, features and advantages will be apparent from the following description of particular embodiments of the present disclosure, as illustrated in the accompanying drawings in which like reference characters refer to the same parts throughout the different views. The drawings are not necessarily to scale, emphasis instead being placed upon illustrating the principles of various embodiments of the present disclosure.

FIG. 1 is a view of a remotely controlled vehicle equipped with certain electronic safety equipment in accordance with certain embodiments.

FIG. 2 is general view of certain safety aspects provided by the electronic safety equipment in accordance with certain embodiments.

FIG. 3 is a block diagram of certain components of the remotely controlled vehicle in accordance with certain embodiments.

FIG. 4 is a flowchart of a procedure to control a vehicle in accordance with certain embodiments.

FIG. 5 is a block diagram of certain components involved in performing a safety evaluation operation in accordance with certain embodiments.

FIG. 6 is a block diagram of other components involved in performing another safety evaluation operation in accordance with certain embodiments.

FIG. 7 is a block diagram of yet other components involved in performing yet another safety evaluation operation in accordance with certain embodiments.

### DETAILED DESCRIPTION

Standoff distances, which are minimum distances to be maintained by personnel for safety during operation, may be imposed for robotic vehicles. For example, if a particular robotic vehicle can travel 100 feet in the time it takes the human operator to command an emergency stop, and the robotic vehicle to execute the emergency stop, then the imposed safety standoff distance will generally be some distance greater than 100 feet to protect personnel from being struck by the vehicle.

However, even with such imposed standoff distances, situations may arise in which the human operator expects certain vehicle operating conditions to currently exist, but the actual vehicle operating conditions are different. For example, using a controller to remotely control the robotic vehicle, the operator may provide a command to the vehicle to move the vehicle forward but a flaw or bug in the electronics of the vehicle may cause the vehicle to move in the opposite direction. Such improper operation could result from the use of commercial off the shelf (COTS) components thus limiting or preventing the vehicle supplier from thoroughly developing and testing those components against certain defects.

As another example, the operator may view video output from a camera of the vehicle while controlling the vehicle, but nevertheless incorrectly understand the current vehicle situation. For example, excessive latency in rendering the video output to the operator may cause the operator to believe certain structures or personnel are still relatively far ahead of the vehicle even though the vehicle has since moved much closer.

In such a situation, the operator may be unaware that personnel are now immediately in front of the vehicle or that the vehicle has already moved in front of a structure.

It the above-described example situations, in which the human operator expects certain vehicle operating conditions to currently exist but the actual vehicle operating conditions are different, there may be a greater likelihood of causing injury and/or damage. What is needed, therefore, is a way to provide assured control for a robotic vehicle which addresses discrepancies between expected vehicle operating conditions and actual vehicle operating conditions.

The above need is addressed at least in part by improved techniques which involve a safety evaluation operation which provides a safety evaluation signal indicating whether a set of actual vehicle conditions aligns with a set of expected vehicle conditions. For example, while a remote user is operating a vehicle, the safety evaluation operation may detect whether the actual vehicle direction matches the expected vehicle direction and/or verify whether the actual vehicle speed is aligned with the expected vehicle speed as commanded by a remote vehicle controller. As another example, the safety evaluation operation may evaluate video information such as timestamps and frame numbers from a video feed received directly from a vehicle camera against a copy of the video information that has been sent to and returned from the vehicle controller to ascertain whether video rendered to the remote user has been timely rendered and remained intact. If there is an unreasonable discrepancy between the set of actual vehicle conditions and the set of expected vehicle conditions, the safety evaluation signal may transition the vehicle to a safeguarded state by triggering an emergency stop. Accordingly, such techniques are able to prevent injury, harm to adjacent structures, vehicle damage, and so on.

The various individual features of the particular arrangements, configurations, and embodiments disclosed herein can be combined in any desired manner that makes technological sense. Additionally, such features are hereby combined in this manner to form all possible combinations, variants and permutations except to the extent that such combinations, variants and/or permutations have been expressly excluded or are impractical. Support for such combinations, variants and permutations is considered to exist in this document.

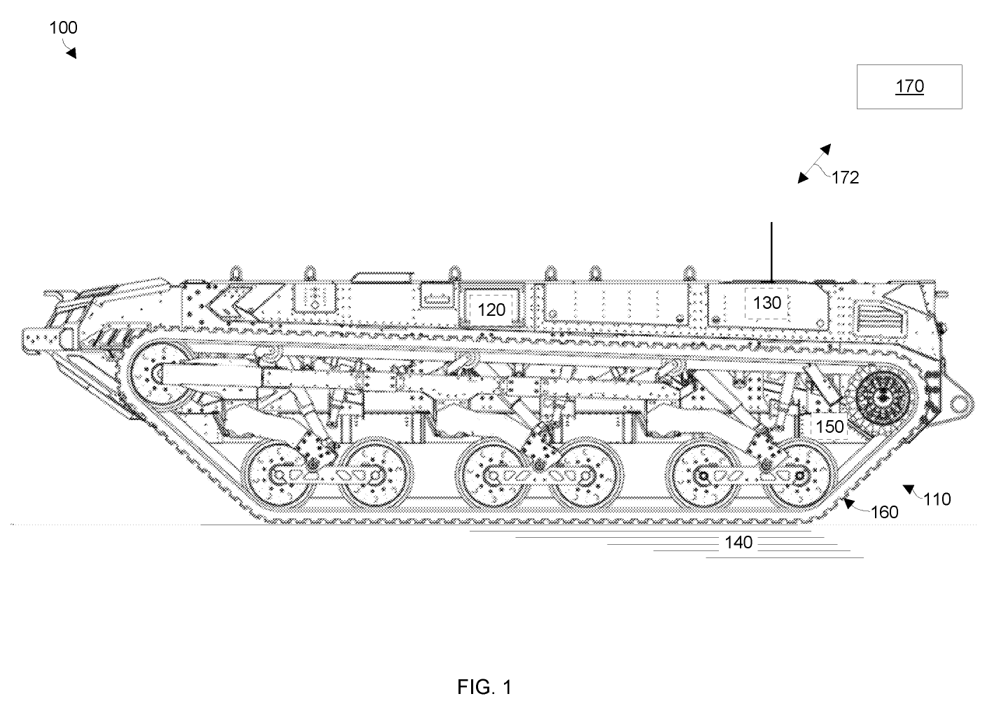

FIG. 1 is a side view of a remotely controlled vehicle 100 equipped with certain electronic safety equipment in accordance with certain embodiments. The vehicle 100 includes, among other things, a vehicle propulsion system 110, vehicle sensors 120, and electronic safety equipment 130.

The vehicle propulsion system 110 is constructed and arranged to move the vehicle 100 over a ground surface 140. Along these lines, the vehicle propulsion system 110 may include a set of motors 150, a set of ground engagement members 160 (e.g., tires, tracks, skis, combinations thereof, etc.), and so on.

The vehicle sensors 120 is constructed and arranged to sense various vehicle conditions and output such sensed vehicle conditions as electronic signals. Along these lines, the vehicle sensors 120 include sensors that detect/measure vehicle speed, vehicle turning direction, vehicle transmission direction, vehicle brake status, etc. The vehicle sensors 120 further includes cameras (e.g., visible light cameras, infrared cameras, etc.). Other vehicle sensors are suitable for use as well such as microphones, other environment detection/measuring devices, comparing circuitry to compare signals from redundant sensing circuits, and so on.

The electronic safety equipment 130 couples with the vehicle propulsion system 110 and the vehicle sensors 120, and is capable of communicating with a vehicle controller 170 that a user operates to control the vehicle 100 remotely, e.g., via wireless communications 172. Along these lines, the user may be equipped with input/output equipment such as levers, switches, joysticks, buttons, video displays, speakers, etc. Such equipment may be in the form of handheld devices, dashboard devices, display screens, tablets, combinations thereof, and so on.

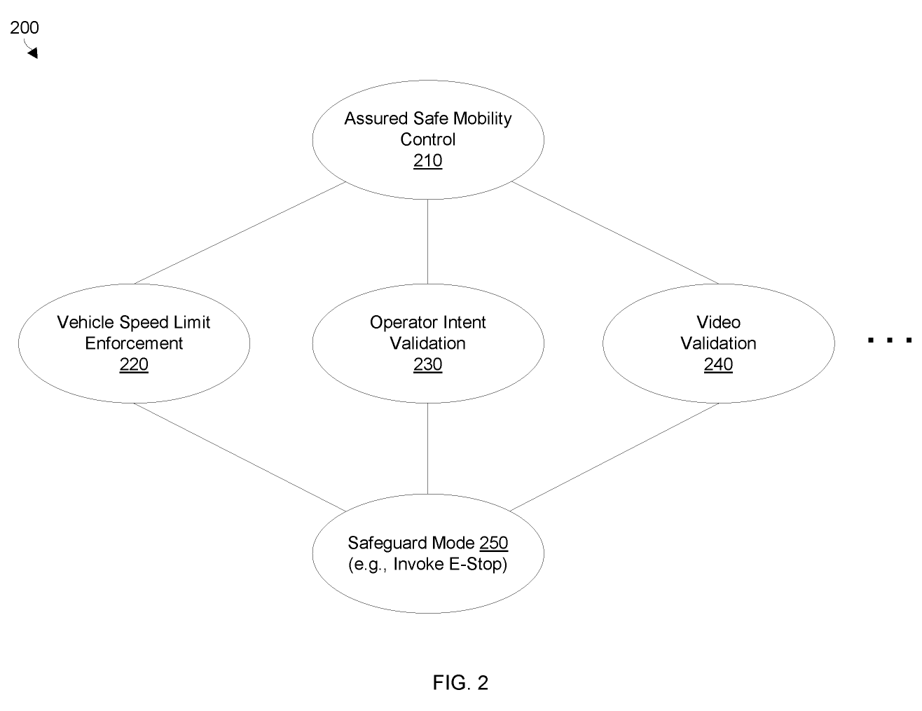

As will be explained in further detail shortly, the electronic safety equipment 130 confirms alignment between actual vehicle conditions and expected vehicle conditions. Along these lines, if there is an unreasonable discrepancy between actual vehicle conditions and the expected vehicle conditions, the electronic safety equipment 130 immediately brings the vehicle 100 to a safeguarded state (e.g., by cutting off power to the motor system, by releasing the brakes, combinations thereof, and so on). Further details will now be provided with reference to FIG. 2.

FIG. 2 is a view 200 of certain safety aspects provided by the electronic safety equipment 130 of the vehicle (FIG. 1) in accordance with certain embodiments. Overall, the electronic safety equipment 130 provides assured safe mobility control 210. Along these lines, such assured safe mobility control 210 includes multiple safety features such as vehicle speed limit enforcement 220, operator intent validation 230, and video validation 240, perhaps among other things.

Vehicle speed limit enforcement 220 refers to a feature of the electronic safety equipment 130 which monitors the current speed of the vehicle 100. If the current speed of the vehicle 100 exceeds a predefined maximum speed limit, the electronic safety equipment 130 automatically transitions the vehicle 100 to a safeguard mode 250 (e.g., an emergency stop). Accordingly, personnel in the vicinity are safeguarded from any malfunction or unintended operation of the vehicle 100. Moreover, since such triggering occurs automatically via the operation of the electronic safety equipment 130, there is no need for a user to visually deduce that the vehicle 100 has exceeded the maximum speed before manually safeguarding the vehicle 100.

Operator intent validation 230 refers to a feature of the electronic safety equipment 130 which validates user intent with actual vehicle behavior. Along these lines, as the user is operating the vehicle 100, the electronic safety equipment 130 compares a set of expected (or intended) vehicle conditions as indicated by a set of vehicle controller signals from the vehicle controller 170 with a set of actual vehicle conditions as indicated by a set of sensor signals from the set of vehicle sensors 120 (also see FIG. 1). Such conditions may include vehicle speed, vehicle direction, transmission direction, and so on. If there is an unreasonable discrepancy between user intent and actual vehicle behavior, the electronic safety equipment 130 transitions the vehicle 100 to the safeguard mode 250.

Video validation 240 refers to a feature of the electronic safety equipment 130 which validates that the video information was properly accessed by the user. Along these lines, as the user is operating the vehicle 100, the electronic safety equipment 130 compares video information such as timestamps and frame of a video feed received directly from a vehicle camera against a copy of the video information that has been sent to and returned from the vehicle controller 170 to ascertain whether video rendered to the user has been timely rendered and remained intact. If there is an unreasonable discrepancy between the direct video information and the returned copy of the video information, the electronic safety equipment 130 transitions the vehicle 100 to the safeguard mode 250.

In some arrangements, the vehicle 100 is equipped with multiple cameras facing in various directions. Accordingly, the vehicle 100 is able to provide views in multiple directions to accommodate moving in multiple directions.

Once the vehicle 100 has transitioned to the safeguard mode 250, the vehicle 100 is in a safe state and there is no longer an opportunity for the vehicle 100 to cause harm due to a discrepancy between actual vehicle conditions and expected vehicle conditions. Rather, the vehicle 100 is now immobilized.

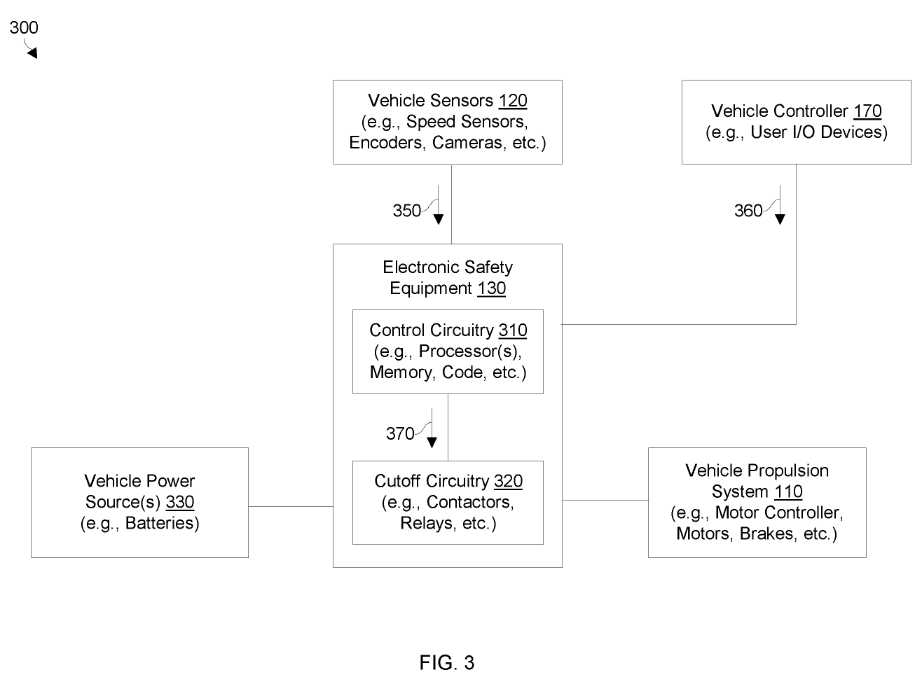

A vehicle and/or related equipment suitable for implementing one or more of the above-described features for assured safe mobility control 210 is disclosed in U.S. Application No. 63/465,933 filed on May 12, 2023, entitled "Remotely Controlled Heavy Vehicle with Safety Standoff Distance Limiter", the contents and teachings of which are hereby incorporated by reference in their entirety. Further details of such a vehicle and/or equipment are provided in U.S. Application No. 18/658,515 filed on May 8, 2024, entitled " Remotely Controlled Heavy Vehicle with Safety Standoff Distance Limiter ", the contents and teachings of which are hereby incorporated by reference in their entirety. Further details will now be provided with reference to FIG. 3.

FIG. 3 shows a view 300 of certain componentry details of the vehicle 100 (also see FIG. 1) in accordance with certain embodiments. As shown, the electronic safety equipment 130 includes control circuitry 310 and cutoff circuitry 320. Along these lines, the control circuitry 310 may be formed by a set of processors, memory, and specialized code stored in the memory. When the set of processors execute the specialized code, the set of processors form specialized circuitry, i.e., all or parts of the control circuitry 310, which performs various operations for assured safe mobility control 210 (e.g., see FIG. 2).

The cutoff circuitry 320 includes various control and power switching equipment which connect the vehicle propulsion system 110 to and disconnect the vehicle propulsion system 110 from one or more vehicle power sources 330. When such switching apparatus are closed, the vehicle propulsion system 110 has access to power from vehicle power sources 330. However, when such apparatus are opened, the vehicle propulsion system 110 is cutoff from receiving power from the vehicle power sources 330. Accordingly, the cutoff circuitry 320 serves as a safety assurance circuit which can disconnect the vehicle propulsion system 110 from one or more vehicle power sources 330 to perform (or carry out) an emergency stop. Similar apparatus which are suitable for use as all or part of the cutoff circuitry 320 is the safety standoff distance limiter disclosed in above-referenced U.S. Application No. 18/658,515.

Along these lines and in the context of electrical control, the cutoff circuitry 320 may include contactors, relays, etc. However, nothing precludes the cutoff circuitry 320 from involving other types of connection/disconnection apparatus such as fuel lines, hydraulics, mechanical linkage, and so on.

During operation, the electronic safety equipment 130 receives sensor signals 350 from the vehicle sensors 120 and vehicle controller signals 360 from the vehicle controller 170. The control circuitry 310 of the electronic safety equipment 130 further performs safety evaluation operations which provides a safety evaluation signal indicating whether there are any discrepancies between actual vehicle conditions as indicated by the sensor signals 350 and expected vehicle conditions as indicated by the vehicle controller signals 360.

If there is a significant discrepancy (e.g., an actual vehicle condition and an expected condition are out of alignment by a predefined tolerance threshold), the control circuitry 310 triggers the cutoff circuitry 320 to disconnect one or more components of the vehicle propulsion system 110 from one or more components of the vehicle power sources 330. Such operation thus safeguards the vehicle 100 (FIG. 1) from causing any harm.

In some arrangements, the vehicle propulsion system 110 includes a motor, a motor controller, and brakes. The motor requires electric power for propulsion.

Additionally, the motor controller requires electric power to control the motor. Furthermore, the brakes are spring biased to the engaged position and require hydraulic power to disengage to enable the vehicle 100 to move. Here, the control circuitry 310 provides a safety evaluation signal 370 to the cutoff circuitry 320 to maintain the vehicle 100 in a normal operating mode while the actual vehicle conditions align with the expected vehicle conditions. However, the cutoff circuitry 320 is able to place the vehicle 100 in a safety assured mode (e.g., see the safeguard mode 250 in FIG. 2) when the actual vehicle conditions do not align with the expected vehicle conditions by simply disconnecting the motor, the motor controller, and the brakes from the vehicle power source(s) 330 (e.g., batteries).

In some arrangements, the connecting devices (e.g., contactors, relays, etc.) of the cutoff circuitry 320 are spring biased to the opened (or disconnected) positions and require power to electromechanically remain in the closed positions. In such arrangements, the control circuitry 310 simply stops delivering power to the cutoff circuitry 320. In response, the connecting devices automatically open such that the motor stops and the brakes engage bringing the vehicle 100 to an immediate emergency stop.

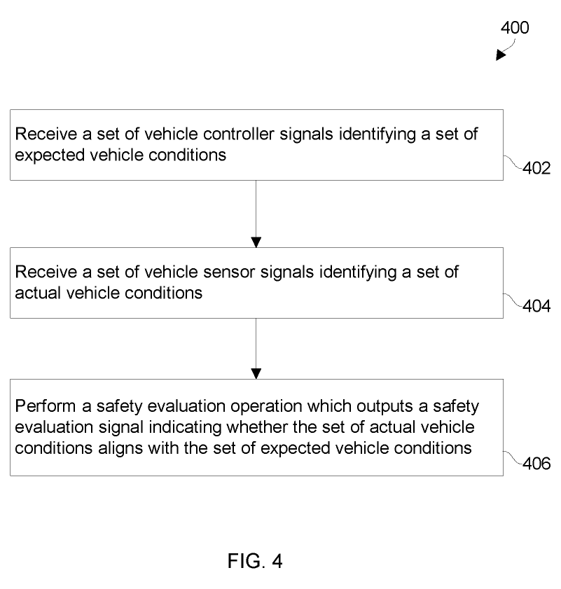

In some embodiments, rather than disconnect power from the motor, the control circuitry 310 directs the vehicle propulsion system 110 to hold the motor in place (e.g., to prevent any further rotation or movement of the ground engagement members 160, see FIG. 1). In these embodiments, there is active control imposed on the motor when the actual vehicle conditions do not align with the expected vehicle conditions. Further details will now be provided with reference to FIG. 4.

FIG. 4 shows a procedure 400 for remotely operating a vehicle in accordance with certain embodiments. Such a procedure may be performed by specialized circuitry of the vehicle to provide assured safe mobility control 210 (also see FIG. 2).

At 402, the specialized circuitry receives a set of vehicle controller signals from a vehicle controller which is external to the remotely controlled vehicle. The set of vehicle controller signals identifies a set of expected vehicle conditions (e.g., expected vehicle speed, expected vehicle direction, video information returned after receiving and rendering video from a vehicle camera, combinations thereof, etc.).

At 404, the specialized circuitry receives a set of vehicle sensor signals from a set of sensors of the remotely controlled vehicle. The set of vehicle sensor signals identifies a set of actual vehicle conditions (e.g., actual vehicle speed, actual vehicle direction, video information obtained directly from a vehicle camera, combinations thereof, etc.).

At 406, the specialized circuitry performs a safety evaluation operation which outputs a safety evaluation signal indicating whether the set of actual vehicle conditions aligns with the set of expected vehicle conditions. The safety evaluation operation is based on the set of vehicle controller signals and the set of vehicle sensor signals.

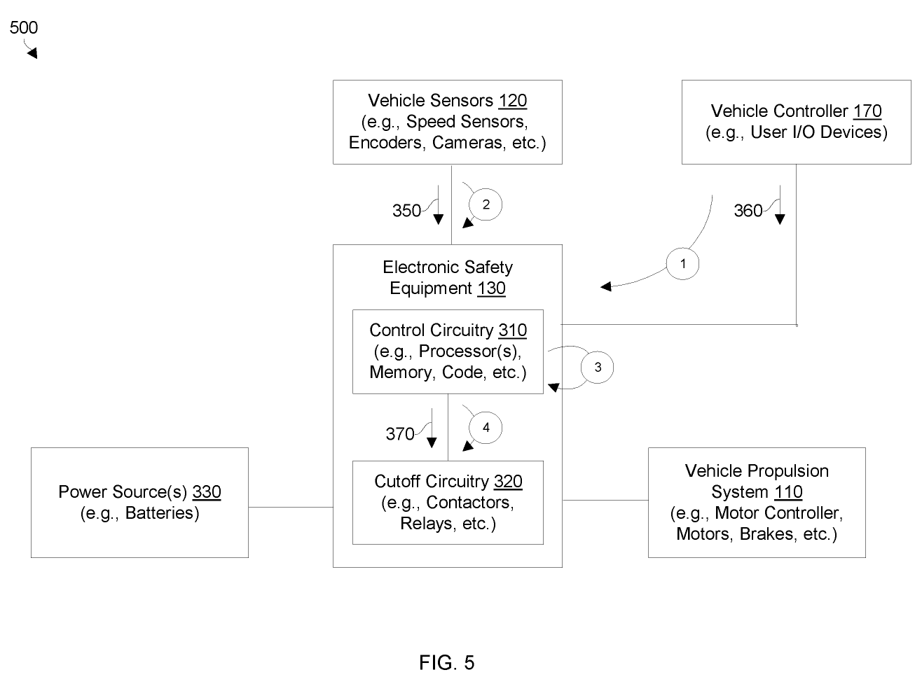

Along these lines, the safety evaluation signal may be provided to a safety assurance circuit onboard the vehicle such as a cutoff circuit, a safety standoff distance limiter (or SSDL), etc. to disable one or more systems of the vehicle. In some arrangements, the safety assurance circuit disconnects power to the motor, the motor controller, and the brakes of the vehicle. Further details will now be provided with reference to FIGS. 5 through 7.

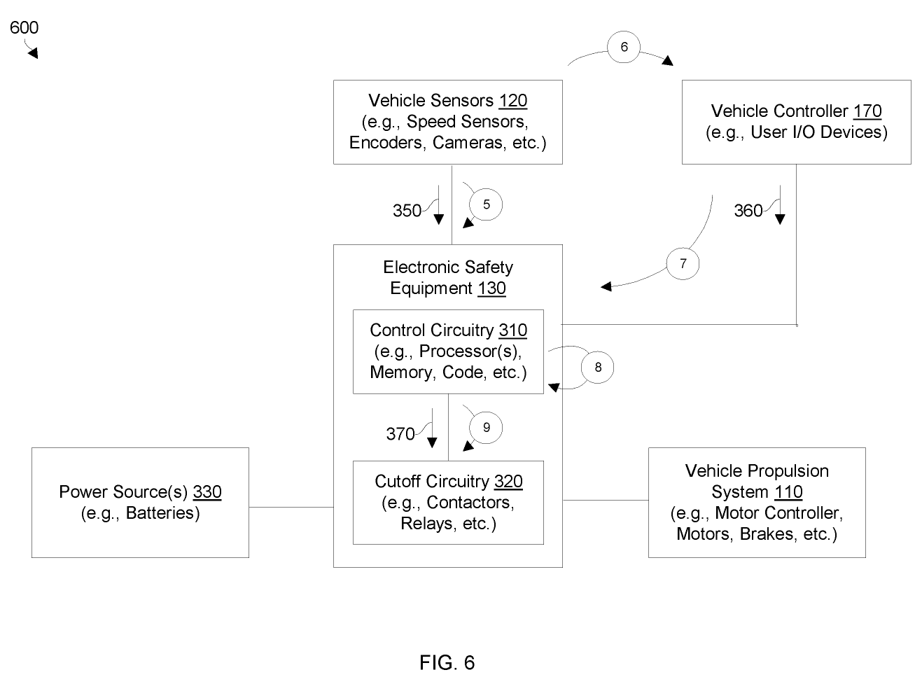

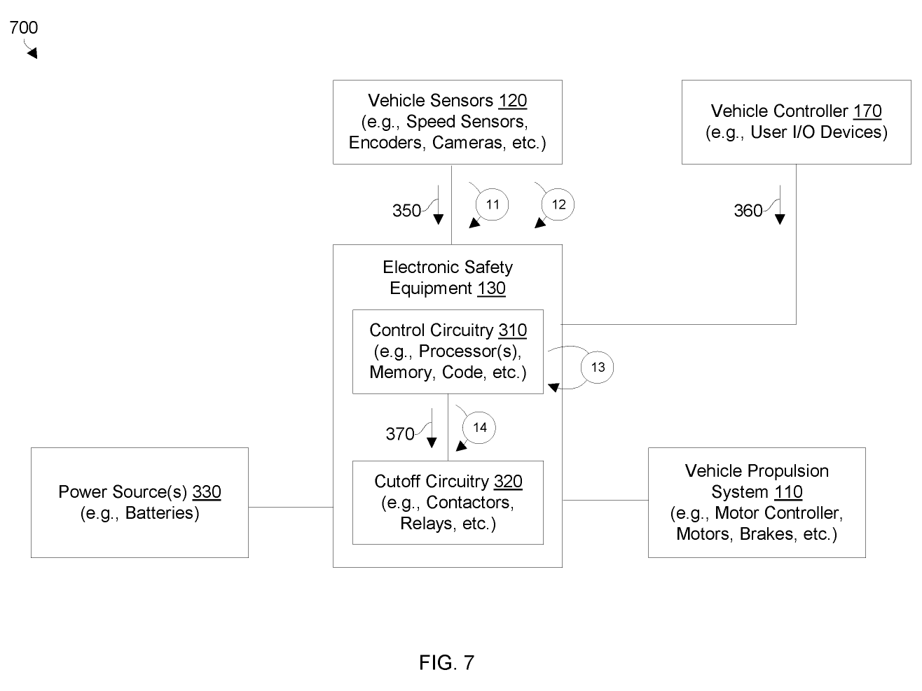

FIGS. 5 through 7 show certain components which are involved in performing a safety evaluation operation to take corrective action in accordance with certain embodiments. FIG. 5 shows a situation which involves evaluating alignment of operator intent with actual vehicle status. FIG. 6 shows a situation which involves detecting potential corruption of a video feed to prevent a user from operating the vehicle while relying on a corrupted video feed. FIG. 7 shows a situation which involves evaluating redundant sensor signals to detect an inconsistency in sensing of an actual vehicle condition.

As just mentioned, FIG. 5 shows a situation 500 which involves evaluating alignment of operator intent with actual vehicle status. If operator intent is not aligned with actual vehicle status, the electronic safety equipment 130 transitions the vehicle 100 (FIG. 1) from a normal operating mode to a safeguard mode (FIG. 2).

Along these lines, the electronic safety equipment 130 obtains, as one or more of the vehicle controller signals 360, a set of vehicle movement commands from the vehicle controller 170 (illustrated by the arrow #1). The set of vehicle movement commands define a set of expected vehicle movement attributes such as intended vehicle speed, intended vehicle direction, intended transmission direction or state (e.g., forward, reverse, neutral), etc.

As further shown in FIG. 5, the electronic safety equipment 130 obtains, as one or more of the vehicle sensor signals 350, a set of vehicle movement signals from the vehicle sensors 120 (illustrated by the arrow #2). The set of vehicle movement signals indicating a set of actual vehicle movement attributes such as actual vehicle speed, actual vehicle direction, actual transmission direction (e.g., forward, reverse, neutral), etc.

The control circuitry 310 of the electronic safety equipment 130 then generates discrepancy values (e.g., a speed discrepancy value indicating a difference between the expected vehicle speed and the actual vehicle speed, a direction comparison value indicating whether the expected vehicle direction matches the actual vehicle direction, etc.). The control circuitry 310 then evaluates whether the discrepancy values fall within reasonable tolerances/requirements. For example, actual vehicle speed and expected vehicle speed should fall within a speed discrepancy threshold and the control circuitry 310 provides a speed alignment result indicating whether the speed difference is within the speed discrepancy threshold. As another example, the actual vehicle direction must match the expected vehicle direction and the control circuitry 310 provides a direction alignment result indicating whether the vehicle directions match, and so on. Such generation and evaluation of discrepancy values is illustrated by the arrow #3 in FIG. 5.

As further shown in FIG. 5, the control circuitry 320 provides the safety evaluation signal 370 to the cutoff circuitry 320. Along these lines, if the control circuitry 310 concludes that any of the expected vehicle movement attributes do not match the actual vehicle movement attributes within the tolerances/requirements, the control circuitry 310 directs the cutoff circuitry 320 to safeguard the vehicle 100, as shown by the arrow #4. Along these lines, the electronic safety equipment 130 may immediately disable the vehicle propulsion system 110 to prevent harm.

As mentioned earlier, FIG. 6 shows a situation which involves detecting potential corruption of a video feed to prevent a user from operating the vehicle 100 while relying on a corrupted video feed. If the electronic safety equipment 130 determines that the user operating the vehicle 100 relied on a corrupted video feed, the electronic safety

equipment 130 transitions the vehicle 100 (FIG. 1) from the normal operating mode to the safeguard mode (FIG. 2).

As shown in FIG. 6, a vehicle camera of the vehicle sensors 120 provides, as one or more of the vehicle sensor signals 350, video information to the electronic safety equipment 130 (illustrated by the arrow #5). Along these lines, the video information may include a series of frames having timestamps, frame or sequence numbers, etc.

Additionally, the same video information is sent to the vehicle controller 170 (illustrated by the arrow #6). Along these lines, one or more wireless links may have been established between the vehicle 100 and the vehicle controller 170 to convey data in both directions. Upon receipt of the video information, video based on the video information is rendered to the user operating the vehicle controller 170. For example, the video information may include a live video feed showing what is in front of the vehicle 100.

Upon rendering the video to the user, the vehicle controller 170 sends back (or returns) at least some of the video information to the electronic safety equipment 130 (illustrated by the arrow #7). Such sent and returned video information, as one or more of the vehicle controller signals 360, may include data representing what was rendered to the user while the user was providing input to the vehicle controller 170 to control the vehicle 100. Along these lines, this remote feed from the vehicle controller 170 may include timestamps indicating when the frames were rendered, the order of the frames as rendered, etc.

Accordingly, at this point, the electronic safety equipment 130 now has received video information such as timestamps and frame numbers from a video feed provided directly from the vehicle camera and, as a remote feed, a copy of the video information that has been sent to and returned from the vehicle controller 170. As a result, the electronic safety equipment 130 is able to competently perform a safety evaluation operation to ascertain whether video rendered to the user had been timely rendered and remained intact (illustrated as arrow #8).

For example, the control circuitry 310 of the electronic safety equipment 130 may evaluate the frame order of the series of frames rendered to the user against the original frame order of the series of frames received directly from the camera. Along these lines, the control circuitry 310 generates frame order results indicating whether any frame discrepancies fall within frame discrepancy tolerances. If a significant discrepancy exists (e.g., more than a predefined number of frames were lost or returned out of order), the control circuitry 310 may conclude that the video rendered to the user was not intact.

As another example, the control circuitry 310 may compute timestamp differences between the series of frames rendered to the user and the original series of frames received directly from the camera. Along these lines, the control circuitry 310 generates timestamp alignment results indicating whether the timestamp differences satisfy timestamp discrepancy tolerances. If the timestamp differences exceed one or more predefined discrepancy thresholds, the control circuitry 310 may conclude that the video was not rendered to the user in a timely manner and the user may have relied on video with long latency.

As further shown in FIG. 6, the control circuitry 320 provides the safety evaluation signal 370 to the cutoff circuitry 320, as shown by the arrow #9. Along these lines, if the control circuitry 310 concludes that any of the discrepancies exceed predefined discrepancy tolerances, the control circuitry 310 directs the cutoff circuitry 320 to safeguard the vehicle 100. Along these lines, the electronic safety equipment 130 may immediately disable the vehicle propulsion system 110 to prevent harm.

As mentioned earlier, FIG. 7 shows a situation which involves evaluating redundant sensor signals to detect an inconsistency in sensing of an actual vehicle condition. Along these lines, at least for certain vehicle sensors 120, redundancy exists thus enabling the electronic safety equipment 130 to safeguard the vehicle 100 if the electronic safety equipment 130 concludes that a vehicle sensor 120 may have malfunctioned.

Along these lines and in accordance with certain embodiments, the vehicle 100 may have two condition sensors to measure a specific vehicle condition (e.g., vehicle speed, vehicle direction, etc.). In this situation, the electronic safety equipment 130 obtains a first condition signal from a first condition sensor (arrow #11) and a second condition signal from a second condition sensor (arrow #12).

The control circuitry 310 of the electronic safety equipment 130 then performs a safety evaluation operation (arrow #13) to determine whether the first condition signal and the second condition signal are consistent with each other. Along these lines, the control circuitry 310 compares the conditions indicated by the first condition signal and the second condition signal to confirm that the condition sensors are operating properly. If the conditions are within a predefined discrepancy threshold, the control circuitry 310 concludes that the condition sensors are operating properly. However, if a difference in the conditions is not within the predefined discrepancy threshold, the control circuitry 310 concludes that one or both of the condition sensors are unreliable.

The control circuitry 310 then outputs a safety evaluation signal indicating whether the first condition signal and the second condition signal are consistent with each other (arrow #14). This safety evaluation signal determines whether the cutoff circuitry 320 transitions the vehicle to the safeguard mode (e.g., perform an emergency stop when the condition signals are inconsistent).

The vehicle 100 may be constructed and arranged to operate as shown in any of the situations of FIGS. 5 through 7. In some embodiments, the vehicle 100 operates such that all of the situations in FIGS. 5 through 7 occur in parallel while a user remotely controls the vehicle 100 via the vehicle controller 170. For example, the safety evaluation signal triggers the cutoff circuitry 320 to safeguard the vehicle 100 in response to misalignment of conditions in any of the situations.

As described above, an improved technique is directed to providing a safety evaluation signal indicating whether a set of actual vehicle conditions aligns with a set of expected vehicle conditions. For example, while a user is operating a remoted controlled vehicle 100, the safety evaluation operation may detect whether the actual vehicle direction matches the expected vehicle direction and/or verify whether the actual vehicle speed is aligned with the expected vehicle speed as commanded by a remote vehicle controller 170. As another example, the safety evaluation operation may evaluate video information such as timestamps and frame numbers from a video feed received directly from a vehicle camera against a copy of the video information that has been sent to and returned from the vehicle controller 170 to ascertain whether video rendered to the remote user has been timely rendered and remained intact. If there is an unreasonable discrepancy between the set of actual vehicle conditions and the set of expected vehicle conditions, the safety evaluation signal transition the vehicle 100 to a safeguard mode such as trigger an emergency stop. Accordingly, such a technique is able to prevent injury, harm to adjacent structures, vehicle damage, and so on.

It should be appreciated that a conventional approach to imposing a vehicle standoff may involve the use of a safety operator controlling a separate emergency stop remote to actuate an emergency stop on the uncrewed vehicle when the safety operator observes unsafe vehicle behavior. Alternatively, software monitoring may be used to affect an emergency stop on the system when qualifying unsafe behavior is detected by the software.

It should be understood that a challenge of operating an uncrewed electric vehicle (i.e., robotic vehicle) is the large motor torque at low speed that, in the event of a serious control failure, could result in an uncontrolled vehicle acceleration and resulting damage/injury. If such a hazard is not adequately mitigated, then safety concerns dictate a requirement for very large separation (standoff distances) between personnel and the uncrewed vehicle. One mitigation approach is the use of a Safety Standoff Distance Limiter (SSDL), which provides an ability to transition the vehicle into a safe state when a configured speed limit is exceeded. The SSDL is responsible for ensuring the vehicle does not exceed the configured maximum speed, such as by use of an emergency stop mechanism upon detecting excessive vehicle speed.

In accordance with certain embodiments, there is a Safety Assured Control Architecture/System for robotic vehicles such as uncrewed ground vehicles or other types of remotely controlled movable apparatus. The system can maintain a desired level of safety-certified control while still allowing use of commercial off-the-shelf (COTS) components and third-party self-driving technologies. In one broad aspect, the system includes functionality for comparing operator/controller intent against vehicle actions and stopping vehicle motion if the intent and actions do not match. In another broad aspect, the system employs safety video monitoring with protection against faulty operation that could impair an operator’s ability to detect an unsafe condition.

In one embodiment, the system is implemented by an operator control unit (OCU) in communication with a mobility base platform (MBP) located on the remote vehicle. The OCU may include a handheld controller used by an operator.

In accordance with certain embodiments, important improvements are included in at least one or more of the following areas: 1. Components/features of an updated SSDL having features beyond the above-mentioned speed limiting functionality. 2. The OCU and handheld controller insofar as configured and operative to realize the enhanced safety control features described herein. 3. The overall Assured Control architecture/system having rich safety-assurance functionality that may be implemented using other specific components/arrangements.

One embodiment is directed to a remotely controlled vehicle which includes a vehicle propulsion system constructed and arranged to move the remotely controlled vehicle. The vehicle further includes a set of sensors. The vehicle further includes electronic safety equipment coupled with the vehicle propulsion system and the set of sensors. The electronic safety equipment is constructed and arranged to perform a method of: (A) receiving a set of vehicle controller signals from a vehicle controller which is external to the remotely controlled vehicle, the set of vehicle controller signals being used to control the vehicle propulsion system and identifying a set of expected vehicle conditions; (B) receiving a set of vehicle sensor signals from the set of sensors, the set of vehicle sensor signals identifying a set of actual vehicle conditions; and (C) based on the set of vehicle controller signals and the set of vehicle sensor signals, performing a safety evaluation operation which outputs a safety evaluation signal indicating whether the set of actual vehicle conditions aligns with the set of expected vehicle conditions.

Another embodiment is directed to electronic safety equipment to control a remotely controlled vehicle. The electronic safety equipment includes memory and processing circuitry coupled with the memory. The memory stores instructions which, when carried out by the processing circuitry, cause the processing circuitry to perform a method of:
(A) receiving a set of vehicle controller signals from a vehicle controller which is separate from the remotely controlled vehicle, the set of vehicle controller signals identifying a set of expected vehicle conditions;
(B) receiving a set of vehicle sensor signals from a set of sensors of the remotely controlled vehicle, the set of vehicle sensor signals identifying a set of actual vehicle conditions; and
(C) based on the set of vehicle controller signals and the set of vehicle sensor signals, performing a safety evaluation operation which outputs a safety evaluation signal indicating whether the set of actual vehicle conditions aligns with the set of expected vehicle conditions.

Yet another embodiment is directed to a method of operating a remotely controlled vehicle. The method includes:
(A) receiving a set of vehicle controller signals from a vehicle controller which is external to the remotely controlled vehicle, the set of vehicle controller signals identifying a set of expected vehicle conditions;
(B) receiving a set of vehicle sensor signals from a set of sensors of the remotely controlled vehicle, the set of vehicle sensor signals identifying a set of actual vehicle conditions; and
(C) based on the set of vehicle controller signals and the set of vehicle sensor signals, performing a safety evaluation operation which outputs a safety evaluation signal indicating whether the set of actual vehicle conditions aligns with the set of expected vehicle conditions.

In some arrangements, the remotely controlled vehicle includes a safety assurance circuit constructed and arranged to transition the remotely controlled vehicle between a normal operating mode which enables vehicle movement and a safety assured mode which disables vehicle movement. Additionally, the method further includes providing the safety evaluation signal as an input to the safety assurance circuit to (i) maintain the

remotely controlled vehicle in the normal operating mode when the set of actual vehicle conditions aligns with the set of expected vehicle conditions and (ii) place the remotely controlled vehicle in the safety assured mode when the set of actual vehicle conditions does not align with the set of expected vehicle conditions.

In some arrangements, the remotely controlled vehicle further includes a motor constructed and arranged to provide vehicle propulsion in response to power, a motor controller constructed and arranged to control the motor in response to power, and a set of brakes constructed and arranged to disengage in response to power to enable the remotely controlled vehicle to move. Additionally, the set of expected vehicle conditions does not align with the set of actual vehicle conditions. Furthermore, providing the safety evaluation signal as the input to the safety assurance circuit includes directing the safety assurance circuit to disconnect power to the motor, the motor controller, and the set of brakes.

In some arrangements, receiving the set of vehicle controller signals from the vehicle controller includes obtaining a set of vehicle movement commands from the vehicle controller, the set of vehicle movement commands defining a set of expected vehicle movement attributes. Additionally, receiving the set of vehicle sensor signals from the set of sensors of the remotely controlled vehicle includes obtaining a set of vehicle movement signals from the set of sensors of the remotely controlled vehicle, the set of vehicle movement signals indicating a set of actual vehicle movement attributes.

In some arrangements, the set of expected vehicle movement attributes includes an expected vehicle speed. Additionally, the set of actual vehicle movement attributes includes an actual vehicle speed. Furthermore, performing the safety evaluation operation includes: (i) based on the expected vehicle speed and the actual vehicle speed, generating a speed discrepancy value indicating a difference between the expected vehicle speed and the actual vehicle speed, and (ii) providing a speed alignment result indicating whether the speed discrepancy value is above or below a vehicle speed safety threshold.

In some arrangements, the set of expected vehicle movement attributes includes

an expected vehicle direction. Additionally, the set of actual vehicle movement attributes includes an actual vehicle direction. Furthermore, performing the safety evaluation operation includes comparing the expected vehicle direction with the actual vehicle direction, and providing a direction alignment result indicating whether the expected vehicle direction matches the actual vehicle direction.

In some arrangements, the set of sensors includes a camera that provides video data. Additionally, receiving the set of vehicle controller signals from the vehicle controller includes obtaining a remote feed from the vehicle controller, the remote feed including at least some of the video data provided by the camera after being received by the vehicle controller and transmitted back from the vehicle controller to the remotely controlled vehicle. Furthermore, receiving the set of vehicle sensor signals from the set of sensors of the remotely controlled vehicle includes obtaining, as a local feed from the camera, the video data provided by the camera.

In some arrangements, the video data provided by the camera includes a series of frames and a series of timestamps corresponding to the series of frames. Additionally, the remote feed from the vehicle controller includes the series of timestamps corresponding to the series of frames after being received by the vehicle controller and transmitted back from the vehicle controller to the remotely controlled vehicle. Furthermore, the local feed includes the series of timestamps corresponding to the series of frames acquired locally from the camera. Also, performing the safety evaluation operation includes generating timestamp differences between the remote feed and the local feed, and providing timestamp alignment results indicating whether the timestamp differences satisfy timestamp discrepancy tolerances.

In some arrangements, the video data provided by the camera includes a series of frames and a corresponding frame order for the series of frames. Additionally, the remote feed from the vehicle controller includes the corresponding frame order for the series of frames after being received by the vehicle controller and transmitted back from the vehicle controller to the remotely controlled vehicle. Furthermore, the local feed includes the corresponding frame order for the series of frames acquired locally from the camera. Also, performing the safety evaluation operation includes matching the corresponding frame order of the remote feed with the corresponding frame order of the local feed to identify frame discrepancies, and providing frame order results indicating whether the frame discrepancies fall within frame discrepancy tolerances.

In some arrangements, the set of sensors of the vehicle includes a first condition sensor constructed and arranged to sense a first vehicle condition and provide a first condition signal, and a second condition sensor constructed and arranged to sense a second vehicle condition and provide a second condition signal. The first vehicle condition and the second vehicle condition are the same. Additionally, the method further includes, based on a first condition signal from the first condition sensor and a second condition signal from the second condition sensor, performing another safety evaluation operation which outputs another safety evaluation signal indicating whether the first condition signal and the second condition signal are consistent with each other.

Further, although features have been shown and described with reference to particular embodiments hereof, such features may be included and hereby are included in any of the disclosed embodiments and their variants. Thus, it is understood that features disclosed in connection with any embodiment are included in any other embodiment.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Although certain embodiments are disclosed herein, it is understood that these are provided by way of example only and should not be construed as limiting.

The foregoing summary is presented for illustrative purposes to assist the reader in readily grasping example features presented herein; however, this summary is not intended to set forth required elements or to limit embodiments hereof in any way. One should appreciate that the above-described features can be combined in any manner that makes technological sense, and that all such combinations are intended to be disclosed herein, regardless of whether such combinations are identified explicitly or not.

While various embodiments of the present disclosure have been particularly shown and described, it will be understood by those skilled in the art that various changes in form and details may be made therein without departing from the spirit and scope of the present disclosure as defined by the appended claims. Such modifications and enhancements are intended to belong to various embodiments of the disclosure.

What is claimed is:

1. A remotely controlled vehicle, comprising:
a vehicle propulsion system constructed and arranged to move the remotely controlled vehicle;
a set of sensors; and
electronic safety equipment coupled with the vehicle propulsion system and the set of sensors, the electronic safety equipment being constructed and arranged to:
receive a set of vehicle controller signals from a vehicle controller which is external to the remotely controlled vehicle, the set of vehicle controller signals being used to control the vehicle propulsion system and identifying a set of expected vehicle conditions;
receive a set of vehicle sensor signals from the set of sensors, the set of vehicle sensor signals identifying a set of actual vehicle conditions; and
based on the set of vehicle controller signals and the set of vehicle sensor signals, perform a safety evaluation operation which outputs a safety evaluation signal indicating whether the set of actual vehicle conditions aligns with the set of expected vehicle conditions.

2. The remotely controlled vehicle of claim 1, further comprising:
a safety assurance circuit constructed and arranged to transition the remotely controlled vehicle between a normal operating mode which enables vehicle movement and a safety assured mode which disables vehicle movement; and
wherein the electronic safety equipment is further constructed and arranged to:
provide the safety evaluation signal as an input to the safety assurance circuit to (i) maintain the remotely controlled vehicle in the normal operating mode when the set of actual vehicle conditions aligns with the set of expected vehicle conditions and (ii) place the remotely controlled vehicle in the safety assured mode when the set of actual vehicle conditions does not align with the set of expected vehicle conditions.

3. The remotely controlled vehicle of claim 2 wherein receiving the set of vehicle controller signals from the vehicle controller includes:
obtaining a set of vehicle movement commands from the vehicle controller, the set of vehicle movement commands defining a set of expected vehicle movement attributes; and
wherein receiving the set of vehicle sensor signals from the set of sensors of the remotely controlled vehicle includes:
obtaining a set of vehicle movement signals from the set of sensors, the set of vehicle movement signals indicating a set of actual vehicle movement attributes.

4. The remotely controlled vehicle of claim 3 wherein the set of sensors further includes a camera that provides video data;
wherein receiving the set of vehicle controller signals from the vehicle controller further includes:
obtaining a remote feed from the vehicle controller, the remote feed including at least some of the video data provided by the camera after being received by the vehicle controller and transmitted back from the vehicle controller to the remotely controlled vehicle; and
wherein receiving the set of vehicle sensor signals from the set of sensors of the remotely controlled vehicle further includes:
obtaining, as a local feed from the camera, the video data provided by the camera.

5. The remotely controlled vehicle of claim 4 wherein the set of sensors of the vehicle further includes a first condition sensor constructed and arranged to sense a first vehicle condition and provide a first condition signal, and a second condition sensor constructed and arranged to sense a second vehicle condition and provide a second condition signal, the first vehicle condition and the second vehicle condition being the same; and
wherein the electronic safety equipment is further constructed and arranged to:
based on a first condition signal from the first condition sensor and a second condition signal from the second condition sensor, perform another safety evaluation operation which outputs another safety evaluation signal indicating whether the first condition signal and the second condition signal are consistent with each other.

6. Electronic safety equipment to control a remotely controlled vehicle, the electronic safety equipment comprising:
memory; and
processing circuitry coupled with the memory, the memory storing instructions which, when carried out by the processing circuitry, cause the processing circuitry to:
receive a set of vehicle controller signals from a vehicle controller which is separate from the remotely controlled vehicle, the set of vehicle controller signals identifying a set of expected vehicle conditions;
receive a set of vehicle sensor signals from a set of sensors of the remotely controlled vehicle, the set of vehicle sensor signals identifying a set of actual vehicle conditions; and
based on the set of vehicle controller signals and the set of vehicle sensor signals, perform a safety evaluation operation which outputs a safety evaluation signal indicating whether the set of actual vehicle conditions aligns with the set of expected vehicle conditions.

7. The electronic safety equipment of claim 6 wherein the remotely controlled vehicle includes a safety assurance circuit constructed and arranged to transition the remotely controlled vehicle between a normal operating mode which enables vehicle movement and a safety assured mode which disables vehicle movement; and
wherein the processing circuitry is further constructed and arranged to:
provide the safety evaluation signal as an input to the safety assurance circuit to (i) maintain the remotely controlled vehicle in the normal operating mode when the set of actual vehicle conditions aligns with the set of expected vehicle conditions and (ii) place the remotely controlled vehicle in the safety assured mode when the set of actual vehicle conditions does not align with the set of expected vehicle conditions.

8. The electronic safety equipment of claim 7 wherein receiving the set of vehicle controller signals from the vehicle controller includes:
obtaining a set of vehicle movement commands from the vehicle controller, the set of vehicle movement commands defining a set of expected vehicle movement attributes; and
wherein receiving the set of vehicle sensor signals from the set of sensors of the remotely controlled vehicle includes:
obtaining a set of vehicle movement signals from the set of sensors of the remotely controlled vehicle, the set of vehicle movement signals indicating a set of actual vehicle movement attributes.

9. The electronic safety equipment of claim 7 wherein the set of sensors includes a camera that provides video data;
wherein receiving the set of vehicle controller signals from the vehicle controller includes:
obtaining a remote feed from the vehicle controller, the remote feed including at least some of the video data provided by the camera after being received by the vehicle controller and transmitted back from the vehicle controller to the remotely controlled vehicle; and
wherein receiving the set of vehicle sensor signals from the set of sensors of the remotely controlled vehicle includes:
obtaining, as a local feed from the camera, the video data provided by the camera.

10. The electronic safety equipment of claim 7 wherein the set of sensors of the vehicle includes a first condition sensor constructed and arranged to sense a first vehicle condition and provide a first condition signal, and a second condition sensor constructed and arranged to sense a second vehicle condition and provide a second condition signal, the first vehicle condition and the second vehicle condition being the same; and
wherein the processing circuitry is further constructed and arranged to:
based on a first condition signal from the first condition sensor and a second condition signal from the second condition sensor, perform another safety evaluation operation which outputs another safety evaluation signal indicating whether the first condition signal and the second condition signal are consistent with each other.

11. A method of operating a remotely controlled vehicle, the method comprising:
receiving a set of vehicle controller signals from a vehicle controller which is external to the remotely controlled vehicle, the set of vehicle controller signals identifying a set of expected vehicle conditions;
receiving a set of vehicle sensor signals from a set of sensors of the remotely controlled vehicle, the set of vehicle sensor signals identifying a set of actual vehicle conditions; and
based on the set of vehicle controller signals and the set of vehicle sensor signals, performing a safety evaluation operation which outputs a safety evaluation signal indicating whether the set of actual vehicle conditions aligns with the set of expected vehicle conditions.

12. The method of claim 11 wherein the remotely controlled vehicle includes a safety assurance circuit constructed and arranged to transition the remotely controlled vehicle between a normal operating mode which enables vehicle movement and a safety assured mode which disables vehicle movement; and
wherein the method further comprises:
providing the safety evaluation signal as an input to the safety assurance circuit to (i) maintain the remotely controlled vehicle in the normal operating mode when the set of actual vehicle conditions aligns with the set of expected vehicle conditions and (ii) place the remotely controlled vehicle in the safety assured mode when the set of actual vehicle conditions does not align with the set of expected vehicle conditions.

13. The method of claim 12 wherein the remotely controlled vehicle further includes a motor constructed and arranged to provide vehicle propulsion in response to power, a motor controller constructed and arranged to control the motor in response to power, and a set of brakes constructed and arranged to disengage in response to power to enable the remotely controlled vehicle to move;
wherein the set of expected vehicle conditions does not align with the set of actual vehicle conditions; and
wherein providing the safety evaluation signal as the input to the safety assurance circuit includes:
directing the safety assurance circuit to disconnect power to the motor, the motor controller, and the set of brakes.

14. The method of claim 12 wherein receiving the set of vehicle controller signals from the vehicle controller includes:
obtaining a set of vehicle movement commands from the vehicle controller, the set of vehicle movement commands defining a set of expected vehicle movement attributes; and
wherein receiving the set of vehicle sensor signals from the set of sensors of the remotely controlled vehicle includes:
obtaining a set of vehicle movement signals from the set of sensors of the remotely controlled vehicle, the set of vehicle movement signals indicating a set of actual vehicle movement attributes.

15. The method of claim 14 wherein the set of expected vehicle movement attributes includes an expected vehicle speed;
wherein the set of actual vehicle movement attributes includes an actual vehicle speed; and
wherein performing the safety evaluation operation includes:
based on the expected vehicle speed and the actual vehicle speed, generating a speed discrepancy value indicating a difference between the expected vehicle speed and the actual vehicle speed, and
providing a speed alignment result indicating whether the speed discrepancy value is above or below a vehicle speed safety threshold.

16. The method of claim 14 wherein the set of expected vehicle movement attributes includes an expected vehicle direction;
wherein the set of actual vehicle movement attributes includes an actual vehicle direction; and
wherein performing the safety evaluation operation includes:
comparing the expected vehicle direction with the actual vehicle direction, and
providing a direction alignment result indicating whether the expected vehicle direction matches the actual vehicle direction.

17. The method of claim 12 wherein the set of sensors includes a camera that provides video data;
wherein receiving the set of vehicle controller signals from the vehicle controller includes:
obtaining a remote feed from the vehicle controller, the remote feed including at least some of the video data provided by the camera after being received by the vehicle controller and transmitted back from the vehicle controller to the remotely controlled vehicle; and
wherein receiving the set of vehicle sensor signals from the set of sensors of the remotely controlled vehicle includes:
obtaining, as a local feed from the camera, the video data provided by the camera.

18. The method of claim 17 wherein the video data provided by the camera includes a series of frames and a series of timestamps corresponding to the series of frames;
wherein the remote feed from the vehicle controller includes the series of timestamps corresponding to the series of frames after being received by the vehicle controller and transmitted back from the vehicle controller to the remotely controlled vehicle;
wherein the local feed includes the series of timestamps corresponding to the series of frames acquired locally from the camera; and
wherein performing the safety evaluation operation includes:
generating timestamp differences between the remote feed and the local feed, and
providing timestamp alignment results indicating whether the timestamp differences satisfy timestamp discrepancy tolerances.

19. The method of claim 17 wherein the video data provided by the camera includes a series of frames and a corresponding frame order for the series of frames;
wherein the remote feed from the vehicle controller includes the corresponding frame order for the series of frames after being received by the vehicle controller and transmitted back from the vehicle controller to the remotely controlled vehicle;
wherein the local feed includes the corresponding frame order for the series of frames acquired locally from the camera; and
wherein performing the safety evaluation operation includes:
matching the corresponding frame order of the remote feed with the corresponding frame order of the local feed to identify frame discrepancies, and
providing frame order results indicating whether the frame discrepancies fall within frame discrepancy tolerances.

20. The method of claim 12 wherein the set of sensors of the vehicle includes a first condition sensor constructed and arranged to sense a first vehicle condition and provide a first condition signal, and a second condition sensor constructed and arranged to sense a second vehicle condition and provide a second condition signal, the first vehicle condition and the second vehicle condition being the same; and
wherein the method further comprises:
based on a first condition signal from the first condition sensor and a second condition signal from the second condition sensor, performing another safety evaluation operation which outputs another safety evaluation signal indicating whether the first condition signal and the second condition signal are consistent with each other.
